(19) United States
(12) Patent Application Publication
(10) Pub. No.: US 2013/0318258 A1
(43) Pub. Date: Nov. 28, 2013

(54) INPUT SYSTEM FOR HOST COMPUTER

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: GUANG-FENG OU, Wuhan (CN); YONG-ZHAO HUANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/900,594

(22) Filed: May 23, 2013

(30) Foreign Application Priority Data
May 25, 2012 (CN) 2012101652696

(51) Int. Cl. G06F 13/38

(52) U.S. Cl. CPC G06F 13/385
USPC 710/14

(57) ABSTRACT

An input system for a host computer includes an input module, a processing unit, and a receiver unit. The input module outputs a first data signal including a key signal corresponding to a key matrix unit, a sensing signal corresponding to a touch sensor, and an operation signals corresponding to first and second buttons. The processing unit is configured to identify the button signal, the sensing signal, and the operation signal, and transmits operation information about the host computer to the receiver unit to be operated by a host computer.

### BACKGROUND

1. Technical Field

The present disclosure relates to an input system for a host computer, especially to a communication process between the input system and the host computer.

2. Description of Related Art

Wireless mice and wireless keyboards independently communicate with host computers. Thus, each wireless mouse and each wireless keyboard includes a processor and an emitter, this increase the cost of the computer.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an input system of the present disclosure, wherein the input system includes a movement detection unit and a processing module.

FIG. 2 is a block diagram of the movement detection unit of FIG. 1.

FIG. 3 is a block diagram of the processing module of FIG. 1.

### DETAILED DESCRIPTION

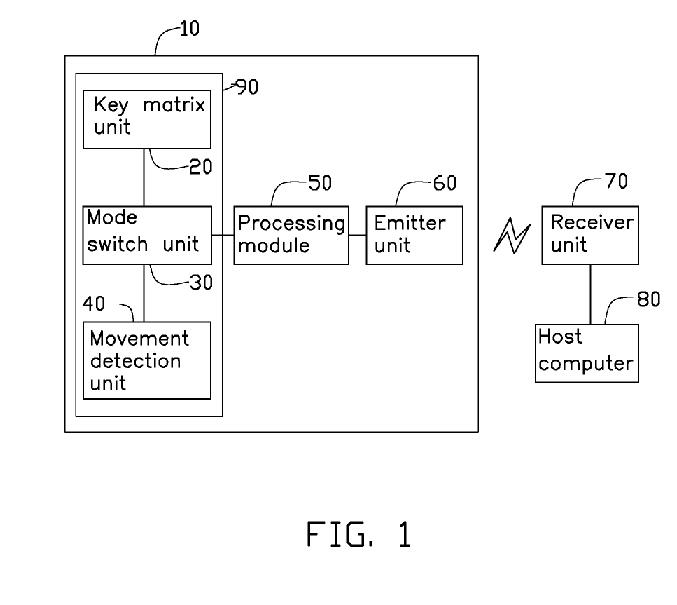

FIG. 1 shows an embodiment of an input system of the present disclosure. The input system communicates with a host computer 80 wirelessly. The input system includes a keyboard 10, and a receiver unit 70 arranged in the host computer 80.

The keyboard 10 includes an input module 90, a processing module 50 configured to receive a first data signal transmitted by the input module 90, and an emitter unit 60 configured to encode a second data signal including input information from the processing module 50 into a third data signal, and transmit the third data signal to the receiver unit 70 of the host computer 80. The host computer 80 decodes the third data signal into input information about the host computer 80, and operates according to the input information.

The input module 90 includes a key matrix unit 20, a movement detection unit 40, and a mode switch unit 30 coupled between the key matrix unit 20 and the movement detection unit 40.

The key matrix unit 20 consists of a plurality of keys characterized in rows and columns (not shown) and outputs key signals according to corresponding keys triggered by fingers of a user. For instance, the key matrix unit 20 outputs a first key signal when a fourth row and second column key is triggered, and the key matrix unit 20 outputs a second key signal when both of the fourth row and second column key and a fifth row and first column key are triggered.

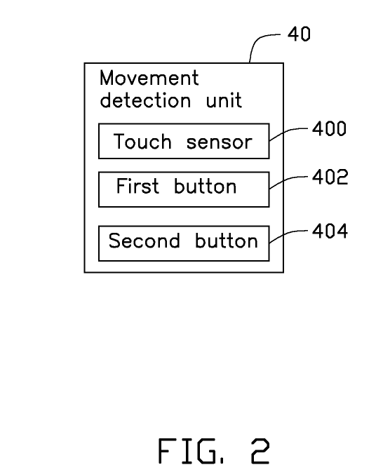

FIG. 2 illustrated that the movement detection unit 40 includes a touch sensor 400, a first button 402, and a second button 404. In the illustrated embodiment, both of the first and second buttons 402 and 404 are separating from the keys of the key matrix unit 20. The touch sensor 400 generates a sensing signal according to a track that the fingers of the user draw on a detection area of the touch sensor 400. The first button 402 is configured to simulate a left button of a mouse, and the second button 404 is to perform the function of a right button of the mouse. The movement detection unit 40 outputs the sensing signal, and outputs operation signals corresponding to the state of the first and second buttons 402 and 404 being pushed. For example, the movement detection unit 40 outputs a left-button click operation signal when the first button 402 is pushed, and outputs a right-button click operation signal when the second button 404 is pushed.

The mode switch unit 30 is a switch arranged on the keyboard 10, and includes first to third statuses corresponding to three different modes of the input module 90, such as a keyboard input mode, a mouse input mode, and a mixed input mode. The first status stands for the mixed input mode, which is configured to output the key signals of the key matrix unit 20, the sensing signal of the touch sensor 400, and the operation signals of the first and second buttons 402 and 404 by the input module 90. The second status stands for the keyboard input mode, which merely outputs the key signals corresponding to the keys of the key matrix unit 20 being triggered by the input module 90. The third status stands for the mouse input mode, which merely outputs the sensing signal corresponding to the touch sensor 400 and the operation signals corresponding to the first and second buttons 402 and 404 by the input module 90. Accordingly, the first data signal outputted by the input module 90 includes at least one type of the key signals, the sensing signals, and the operation signals.

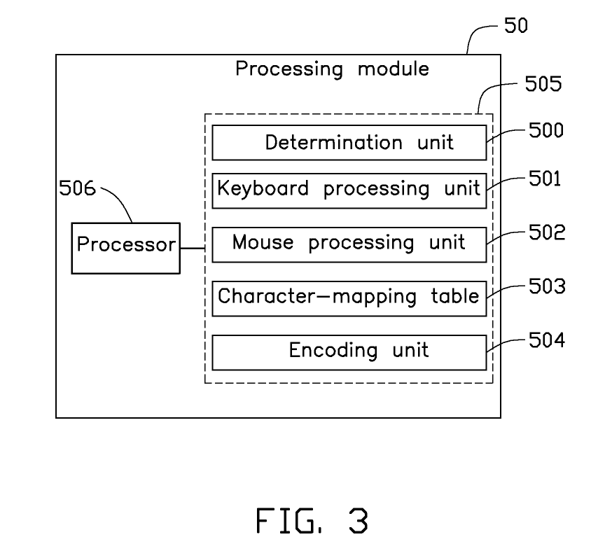

FIG. 3 shows that the processing module 50 is configured to process the first data signal transmitted by the input module 90. The processing module 50 includes a processor 506 and a storage unit 505 storing a plurality of programs to be executed by the processor 506, which includes a determination unit 500, a keyboard processing unit 501, a mouse processing unit 502, a character-mapping table 503, and an encoding unit 504.

The character-mapping table 503 includes a plurality of characters corresponding to the key signals of the key matrix unit 20. For instance, a character “a” may stand for the first key signal and a character “A” stands for the second key signal.

The determination unit 500 is configured to determine whether the first data signal includes the key signals, the sensing signals, or the operation signals.

When the first data signal includes the key signals, the determination module 500 transmits the key signals in relation to the keys of the key matrix unit 90 being triggered to the keyboard processing unit 501. The keyboard processing unit 501 obtains a character from the character-mapping table 503 according to the key signals, and generates a second data signal including character information according to the character, and then the second data signal is transmitted to the encoding unit 504. For example, the keyboard processing unit 501 will obtain the character “a” from the character-mapping table 503 in response to receiving the first key signal, and obtain the character “A” from the character-mapping table 503 in response to receiving the second key signal.

When the first data signal includes at least one type of the sensing signals and the operation signals, the determination unit 500 transmits the at least one type of the sensing signals and the operation signals to the mouse processing unit 502. The mouse processing unit 502 is configured to identify the at least one type of the sensing signals and the operation signals, and generates a second data signal including operation information according to the at least one type of the sensing signals and the operation signals. The second data signal is then transmitted to the encoding unit 504. For example, the mouse processing unit 502 will identify whether the operation signals are the left-button click or right-button click operations, and output a left-button click operation signal to the encoding unit 504.

The encoding unit 504 is configured to encode the second data signal including at least one type of the character information and the operation information into a third data signal, and then transmits the third data signal including the character information and the operation information to the receiver unit 70. Accordingly, the host computer 80 may receive the third data signal, and performs the corresponding operations, such as inputting a character “A”, or closing a window with a left-button click. In this illustrated embodiment, input information for the host computer 80 consists of the character information and the operation information.

When the user needs to input a character “A” to the host computer 80, the mode switch module 30 can be switched to the first or third status. Both of the fourth row and second column key and the fifth row and first column key are then triggered by the user. The key matrix unit 20 outputs the first data signal including the second key signal to the processing module 50 through the mode switch module 30. The determination unit 500 of the processing module 50 determines that the first data signal includes the second key signal, and the first data signal then is transmitted to the keyboard processing unit 501. The keyboard processing unit 501 obtains the character “A” from the character-mapping table 503, and the character information including the character “A” is then transmitted to the encoding unit 504. The encoding unit 504 encodes the character information into the third data signal, and transmits the third data signal to the receiver unit 70 of the host computer 80. The host computer 80 will decode the third data signal to obtain the character “A”.

When the user needs to enable the input module 90 to function as a mouse, such as the first button 402 simulating the left-button click operation, the switch unit 30 may be switched to the second or third status. When the first button 402 is pushed, the movement detection unit 40 outputs the first data signal including the operation signal, that is the left-button click operation signal, to the processing module 50. The determination unit 500 of the processing module 50 determines that the first data signal including the operation signal, and transmits the first data signal to the mouse processing unit 502. The mouse processing unit 502 is configured to detect the operation information of the first data signal, and generates the second data signal including the left-button click operation, and the operating information is then transmitted to the emitter unit 504. The encoding unit 504 encodes the second data signal to the third data signal, and transmits the third data signal to the receiver unit 70 of the host computer 80. The host computer 80 will decode the third data signal to obtain the left-button click operation, such as closing a window.

Accordingly, only one processing module 50 and one emitter unit 60 are employed to transmit the first data signal from the key matrix unit 20 and the movement detection unit 40 to the receiver unit 70 of the host computer 80, and the cost of the input system is lower.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An input system for a host computer, comprising:
an input module comprising a key matrix unit, a mode switch unit, and a movement detection unit, wherein the movement detection unit comprises a touch sensor and first and second buttons, when the mode switch unit is switched to a first status, the mode switch unit outputs a first data signal including a key signal corresponding to the key matrix unit, a sensing signal corresponding to the touch sensor, and an operation signal corresponding to the first and second buttons;
a processing unit comprising a processor and a storage unit storing programs executed by the processor, wherein the storage unit comprises:
a determination unit configured to determine whether the first data signal includes at least one of the first and second button signals, the sensing signal, and the operation signal;
a character-mapping table comprising a plurality of characters corresponding to different key signals;
a keyboard processing unit configured to obtain a character from the character-mapping table according to the key signal transmitted by the determination unit, and generate character information;
a mouse processing unit configured to generate operation information about the host computer corresponding to the sensing signal and the operation signal; and
an emitter unit configured to encode the character information and the operation information into input information, and output the input information; and
a receiver unit arranged in the host computer, and configured to receive the input information to obtain corresponding operations to be performed by the host computer.

2. The input system of claim 1, wherein when the mode switch unit is switched to a second status, the mode switch unit only outputs the key signal from the key matrix unit.

3. The input system of claim 2, wherein when the mode switch unit is switched to a third status, the mode switch unit only outputs at least one of the sensing signal and the operation signal.

4. The input system of claim 3, wherein the first button outputs a left-button mouse click operation signal when being pushed.

5. The input system of claim 3, wherein the second button outputs a right-button mouse click operation signal when being pushed.
